(19) United States
(12) Patent Application Publication
(10) Pub. No.: US 2008/0280167 A1
(43) Pub. Date: Nov. 13, 2008

(54) FUEL CELL STACK PERFORMANCE MONITORING

(75) Inventors: Daniel Rene Hagen Pedersen, Horning (DK); Kristian Silberbauer, Ribe (DK)

Correspondence Address: LOWRIE, LANDO & ANASTASI, LLP, ONE MAIN STREET, SUITE 1100, CAMBRIDGE, MA, 02142, US

(73) Assignee: AMERICAN POWER CONVERSION CORPORATION, W. Kingston, RI (US)

(21) Appl. No.: 11/745,666

(22) Filed: May 8, 2007

(51) Int. Cl. H01M 8/04; H01M 8/00

(52) U.S. Cl. 429/13; 429/22

(57) ABSTRACT

A fuel cell system comprising a first fuel cell and a second fuel cell is provided. In certain examples, the fuel cell system may be configured to provide an operating variable to monitor fuel cell system performance is disclosed. A fuel cell assembly comprising the fuel cell system and methods of monitoring the fuel cell system are also disclosed.

### FIELD OF THE TECHNOLOGY

Certain examples relate to a fuel cell monitoring system. More particularly, certain examples relate to a fuel cell system configured to monitor fuel cell stack performance to adjust or tune the performance of a fuel cell stack.

### BACKGROUND

Fuel cells are electrochemical systems in which electricity is generated from a reaction of fuel and oxidant in the presence of an electrolyte. A fuel cell typically has an anode where oxidation occurs, and a cathode where reduction occurs. Fuel is fed into the anode of the fuel cell, while the oxidant is fed into the cathode of the fuel cell. A bipolar plate is typically arranged at each outer end of the fuel cell. To generate electricity, the fuel and oxidant need to be available in sufficient amounts. If either the fuel or oxidant is not available in sufficient amounts, inefficient operation of the fuel cell may result.

For example, in certain fuel cells, such as direct methanol fuel cells (DMFC), carbon dioxide bubbles may form on the anode side of the fuel cell, resulting in local fuel shortage. Additionally, water droplets may form on the cathode side of the fuel cell, resulting in decreased electrical efficiency of the fuel cell.

### SUMMARY

Certain aspects and examples disclosed herein provide a system configured to monitor fuel cell system performance.

In accordance with a first aspect, a power system may be configured to provide a voltage output. In certain examples, the system may comprise a first voltage generating device and a second voltage generating device coupled to the first voltage generating device. In some examples, the power system may be configured to provide an operating variable that may be used to monitor performance of the system. In yet other examples, the first and second voltage generating device is selected from the group consisting of a fuel cell, a photovoltaic cell and battery.

In accordance with an additional aspect, a fuel cell system comprising a first fuel cell and a second fuel cell is disclosed. In certain examples, the fuel cell system may be configured to provide an operating variable to monitor fuel cell system performance. In some examples, the first fuel cell is configured to receive a lower amount of fuel than the second fuel cell in a first condition. In some examples, the operating variable may be a voltage difference between the first fuel cell and the second fuel cell. In other examples, the operating variable may be a voltage output of at least one of the first and second fuel cells. In certain examples, the fuel cell system may comprise a device configured to provide an operating variable to monitor fuel cell stack performance. In certain other examples, the fuel cell system may comprise a voltage measurement device configured to provide a voltage measurement as the operating variable to monitor fuel cell stack performance. In yet examples, the first condition may provide a voltage output of the first fuel cell that is compared to a voltage output of the second fuel cell to monitor fuel cell stack performance. In certain other examples, a device may be configured to limit the amount of fuel supplied to the first fuel cell. In some examples, the device is a tube or an orifice plate.

In accordance with an additional aspect, the fuel cell system may comprise a fuel source fluidically coupled to the first fuel cell and the second fuel cell. In certain examples, the fuel source is methanol.

In accordance with an additional aspect, the fuel cell system may be configured to provide an operating variable to monitor fuel cell stack performance to limit performance issues. In certain examples, the performance issues may be selected from the group consisting of low concentration of fuel, fuel shortage, carbon dioxide bubble formation, water droplet formation, and combinations thereof.

In accordance with an additional aspect, a fuel cell system comprising a controller and a fuel cell stack is disclosed. In certain examples, the fuel cell stack may comprise a first fuel cell and a second fuel cell. In some examples the fuel cell stack may be configured to provide feedback to the controller regarding fuel cell stack performance. In certain other examples, the controller may adjust the amount of fuel supplied if the feedback is outside of a threshold range. In certain other examples, the controller may adjust the amount of fuel supplied if the feedback is within a threshold range. In some examples, the feedback may be a difference between a first fuel cell voltage output and a second fuel cell voltage output, the first fuel cell voltage output generated under conditions of a decreased amount of fuel supplied to a first fuel cell.

In accordance with an additional aspect, a fuel cell assembly is provided. In certain embodiments, the fuel cell assembly may include a fuel cell stack comprising a first fuel cell and a second fuel cell, a means for reducing the amount of fuel supplied to a first fuel cell, a means for measuring an operating variable of the first fuel cell and the second fuel cell, a means for comparing the value of the operating variable of the first fuel cell and the second fuel cell, and a means for controlling the operating variable of at least one of the first and second fuel cells to maintain the performance of the fuel cell stack. In certain other embodiments, the controller may be configured to provide a change in the amount of fuel supplied if the operating variable is outside of a threshold range. In yet other embodiments, the controller may be configured to provide a change in the amount of fuel supplied if the operating variable is within a threshold range. In some embodiments, a voltage measuring device may be configured to provide a measurement of the first fuel cell and the second fuel cell.

In accordance with another aspect, a method of determining performance of a fuel cell stack is disclosed. In certain embodiments, the method may include limiting fuel supplied to a first fuel cell of the fuel cell stack to induce a performance condition in the first fuel cell to prevent occurrence of the induced performance condition in the fuel cell stack. In yet other embodiments, the method may include measuring a first voltage output of the first fuel cell to determine the performance condition. In some embodiments the method may include measuring a second voltage output of a second fuel cell.

In accordance with an additional aspect, a method of monitoring performance of a fuel cell stack is disclosed. In certain embodiments, the method may include subjecting a first fuel cell of the fuel cell stack to a first condition resulting in a lower amount of fuel supplied to the first fuel cell, detecting a first voltage of the first fuel cell, and monitoring performance of the fuel cell stack using the first voltage output. In certain other embodiments, the method may include comparing the first voltage output and the additional voltage output to assess performance of the fuel cell stack. In some embodiments, the method may include inducing a second condition in the fuel cell stack in response to the assessed performance. In other embodiments the second condition may include adjusting the amount of fuel supplied to the fuel cell stack. In certain other embodiments, the method may include controlling the fuel flow of the fuel cell stack based on the first voltage output and the second voltage output.

Additional features, aspects and examples of the technology are described in more detail below.

### BRIEF DESCRIPTION OF THE FIGURES

Certain illustrative examples are described below with reference to the accompanying figures in which:

FIG. 1 is a first example of a fuel cell stack, in accordance with certain examples;

FIG. 2 is a another example of a fuel cell stack, in accordance with certain examples;

FIG. 3 is an example of a tube, in accordance with certain examples;

FIG. 4 is an example of an orifice plate, in accordance with certain examples;

FIG. 5 is a flow chart of the fuel cell system, in accordance with certain examples; and

FIG. 6 is an example of a fuel cell system, in accordance with certain examples.

Certain features or components of the illustrative fuel cell stacks and fuel cell systems shown in the figures may have been enlarged, distorted or otherwise shown in a non-conventional manner relative to other features or components to facilitate a better understanding of the novel devices and methods disclosed here and to provide a more user friendly description of the technology disclosed herein. It will be recognized by the person of ordinary skill in the art, given the benefit of this disclosure, that the fuel cell stacks and fuel cell systems disclosed here, and methods of their use, can be used in any orientation relative to gravity and suitable orientations will be readily selected by the person of ordinary skill in the art, given the benefit of this disclosure.

### DETAILED DESCRIPTION

Certain embodiments of the devices, systems and methods disclosed herein will be recognized by the person of ordinary skill in the art, given the benefit of this disclosure, to provide simpler, more efficient and cost-effective devices for providing power, and monitoring systems that can offer early indication and prediction of device performance issues. This technology may prevent system failures and degradation, to increase overall efficiency and extend the life of the system and its components.

As used herein, the term “predicting” refers to indicating an outcome in advance based on observations related to an operating variable. The term “operating variable” refers to a variable or a quantity that may change over a period, or during operation of the system. The operating variable may be measured, calculated, or otherwise quantified and may represent at least one value, quantity, amount, boundary, threshold, upper limit, and/or lower limit. The operating variable may be used as an indication of performance or to predict performance of a device or system. In certain examples, an operating variable may be the output of a device or system. In certain other examples, an operating variable may be the voltage output of at least one component. In yet other examples, an operating variable may be the difference between the voltage output of a first component and the voltage output of a second component. The term “inducing” means creating or causing a condition, for example, inducing a first condition in a fuel cell system may refer to an operator intentionally limiting the amount of fuel supplied to a first fuel cell. The term “induced performance condition” is a condition which is created or caused by an intentional act.

Certain examples of the system disclosed herein that provide an operating variable may permit a user to adjust or tune the performance of a system. Changes to the operating variable may indicate or predict a change in performance of the system. By inducing a first condition in the system, an induced performance condition may result in a portion of the system. The system may be monitored, and a second condition may be induced to prevent occurrence of the induced performance condition throughout the system. For example, in a fuel cell system, a change in voltage output of a fuel cell may be used to indicate or predict a change in performance of the system. The change in performance of the system may be related to, for example, a lack of a sufficient amount of fuel supplied to the fuel cell. By inducing a first condition in the system by lowering the amount of fuel supplied to a first fuel cell, the system may be monitored by measuring the voltage output of the first fuel cell, and an additional fuel cell within the system. If the voltage output of the first fuel cell drops below the voltage output of the additional fuel cell, this may indicate a change in performance of the system. The first fuel cell acts as an indicator of future performance of the additional fuel cell and the fuel cell system. This indication may prompt a second condition to be induced, to prevent the occurrence of the first fuel cell's induced performance condition in the additional fuel cell or the entire fuel cell system.

In certain embodiments, the technology disclosed herein may be used in systems including fuel cells, rechargeable and non-rechargeable batteries and battery banks, other electrochemical cells, photovoltaic cells, and other suitable power or voltage generating devices. In certain examples, the technology disclosed herein may be used in continuous operation or intermittently, and may be used as a primary power source or a backup power source. It may replace another type of power generator, or function in conjunction with other power generators. In certain examples, the technology disclosed herein may be used for mobile applications, for example to power automobiles, buses, airplanes, and spacecrafts. In other examples, the technology disclosed herein may be used for portable applications, such as cellular phones, pagers, computers, personal digital assistants, portable media players, cameras, video recording devices (e.g., camcorders), global positioning systems, hearing aids, remote devices, and cordless tools. In other examples, the technology disclosed herein may be used in other small devices such as smoke detectors, radon detectors, carbon monoxide detectors, meter readers, and burglar alarms. In yet other examples, the technology disclosed herein may be used for stationary applications in homes and for commercial purposes. In yet other examples, the technology disclosed herein may be used for uninterruptible power supplies (UPS's), backup power generators, and battery and supercapacitor replacement.

In accordance with certain examples, the systems disclosed herein may be configured to provide a voltage output. In certain embodiments, the system comprises a first voltage generating device coupled to a second voltage generating device. In certain examples, the system may be configured to provide an operating variable used to monitor performance of the system.

In accordance with certain examples, a fuel cell system comprising a fuel cell stack may be configured to provide an operating variable to monitor the performance of a fuel cell stack. The exact configuration of the fuel cell system may vary depending on the type of fuel cell, the fuel, oxidant, and electrolyte used, the fuel cell size, the temperature at which it operates, the pressure at which the fuel and oxidant are supplied to the fuel cell, the fuel concentration, and other variables recognized by the person of ordinary skill in the art.

In certain examples, proton exchange membrane fuel cells (PEMFC) (or polymer electrolyte membrane fuel cells) may be used. This fuel cell uses a polymer membrane as an electrolyte (usually a sulfonic acid polymer such as Nafion®) in the form of a thin, permeable sheet. A platinum catalyst may be used on one or both sides of the membrane. Hydrogen gas may be used as the fuel, and oxygen or air may be used as the oxidant. The operating temperature is about 80° C. to about 90° C.

In certain other examples, a type of PEMFC, direct methanol fuel cells (DMFC), may be used. As in PEMFCs, DMFCs use a polymer membrane as an electrolyte. DMFCs use methanol as a fuel, and oxygen or air as the oxidant. A catalyst, such as platinum, may be used on the anode and/or cathode of the fuel cell.

In certain other examples, solid oxide fuel cells (SOFC) may be used. A ceramic oxide such as calcium oxide or zirconium oxide may be used as an electrolyte. Hydrogen or methane may be used as the fuel. Oxygen or air may be used as the oxidant. This system operates at temperatures from about 650° C. to about 1000° C.

In certain other examples, molten carbonate fuel cells may be used. This type of fuel cell uses alkali carbonates (e.g., sodium, magnesium, lithium or potassium salts) as an electrolyte. The alkali carbonates may be retained in a ceramic matrix of lithium aluminum oxide or other suitable matrix. The fuel may be hydrogen or methane. The oxidant may be oxygen and carbon dioxide, or air. These fuel cells generally use nickel electrode-catalysts and operate from about 600° C. to about 700° C.

In certain other examples, alkaline fuel cells may be used. An aqueous alkaline solution, which may be supported by a matrix, may be used as an electrolyte. Hydrogen may be used as the fuel and oxygen or air may be used as the oxidant. These fuel cells generally use a platinum catalyst and operate from about 100° C. to about 250° C.

In certain other examples, metal hydride fuel cells are a type of alkaline fuel cell that use an aqueous alkaline solution, for example, potassium hydroxide, as an electrolyte.

In certain other examples, phosphoric acid fuel cells may be used. Phosphoric acid is used as the electrolyte and may be retained on a silicon carbide matrix. Hydrogen may be used as the fuel. Oxygen or air may be used as the oxidant. A platinum electrode catalyst may be used. The operating temperature is generally between about 150° C. to about 200° C.

In accordance with certain examples, the fuel cell system may comprise multiple fuel cells arranged together to form a fuel cell stack. This arrangement may make monitoring fuel cell stacks difficult using existing methods and devices. In addition or alternatively, voltage measurements of each fuel cell also may be required adding to the size and complexity of the fuel cell stack system. Additionally, even systems using these types of detection systems do not allow for early indication of performance issues. Often, this results in periodic shutdowns of the fuel cells for maintenance to remove issues such as carbon dioxide bubble formation or water droplet accumulation, lowered system performance, and lowered lifetime due to carbon corrosion. This increases costs associated with operation of the fuel cell system.

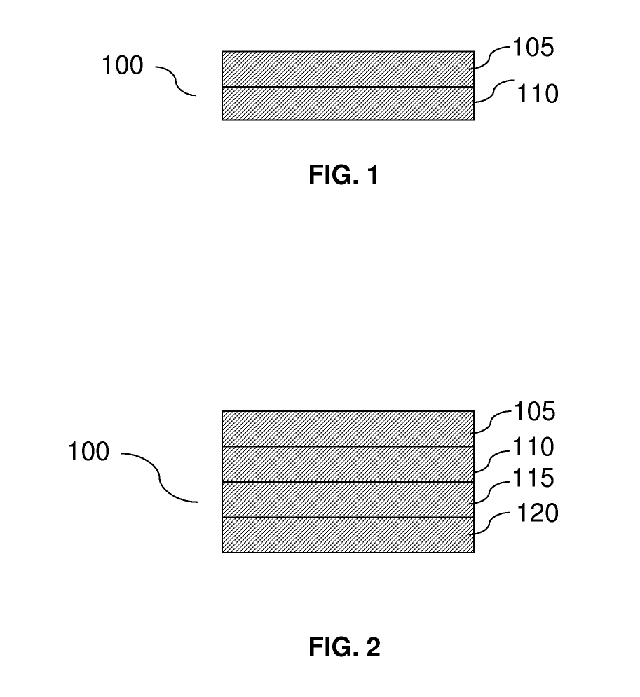

In accordance with certain examples, a fuel cell stack comprising a first fuel cell and a second fuel cell configured to provide an operating variable to monitor fuel cell stack performance is provided. Referring to FIG. 1, a fuel cell stack 100 includes at least two fuel cells 105 and 110. In this example, the fuel cells are shown in series. In other examples, the fuel cells may be arranged in parallel, star-shape, or in other configurations as long as the fuel cells share a common fuel inlet and outlet and/or oxidant inlet and outlet, such that there is a correlation between the fuel or oxidant rate supplied to the fuel cells and their voltages. Design features of the fuel cells may also vary. In certain examples, the fuel cells of the fuel cell stack may share a common fuel inlet and fuel outlet, and a common air inlet and outlet. In certain examples, a manifold may be part of a fuel cell system. The manifold may take on numerous configurations, and may connect multiple stacks to a common fuel inlet and outlet, multiple stacks to a common oxidant inlet and outlet, or a combination of both. In certain examples, one end of the manifold may be fluidically coupled to the fuel supply or fuel source. Another end of the manifold may be fluidically coupled to a fuel cell or fuel cell stack. In other examples, one end of the manifold may be fluidically coupled to the oxidant supply or oxidant source. Another end of the manifold may be fluidically coupled to a fuel cell or fuel cell stack to receive exhaust from the fuel cell or fuel cell stack. It will be within the ability of the person of ordinary skill in the art, given the benefit of the disclosure, to select or to design suitable manifolds for use in the fuel cell systems and fuel cell assemblies disclosed herein. In certain examples, the manifold may be external to the system. In other examples, the manifold may be internal to the system. The internal manifold may be self-contained with the fuel cell system.

In accordance with certain examples, the fuel cell system may be configured to provide an operating variable. Referring to FIG. 1, the operating variable may be a voltage output of the fuel cell 105 or the fuel cell 110. In other examples, the operating variable may be a voltage difference between the fuel cells 105 and 110.

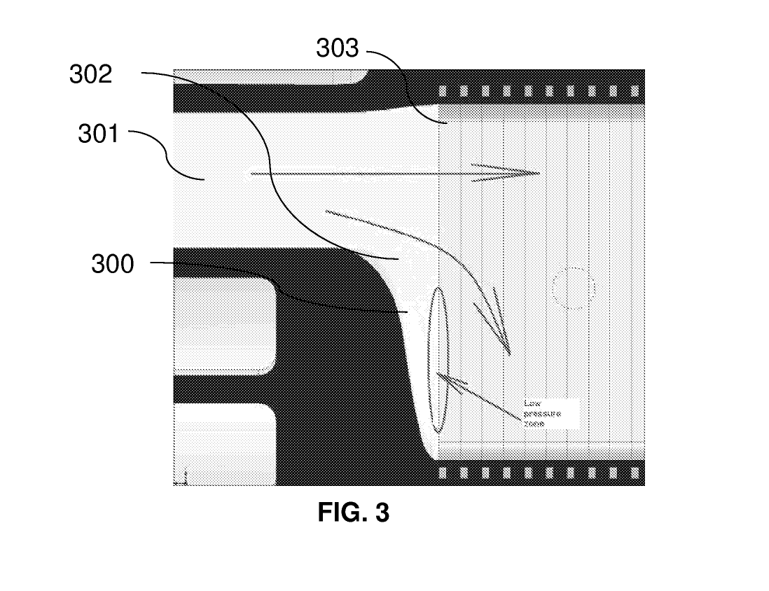

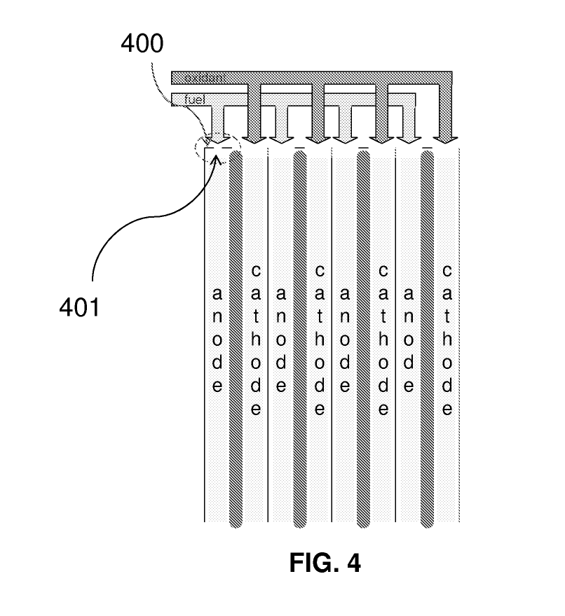

In certain examples, at least one of the fuel cells in a fuel cell stack may be subjected to a first condition resulting in a lower amount of fuel supplied to the at least one fuel cell. The first condition may be implemented by a user, or may occur automatically through use of a computer algorithm, and may be used as an indicator of performance of the fuel cell stack. The exact manner of reducing fuel to the at least one fuel cell stack may be implemented in various ways. Referring to FIG. 3, in certain examples, a Venturi tube 300 controls the amount of fuel supplied to the at least one fuel cell 105. Fuel flows through the manifold 301, and passes through a widened area 302, where the pressure drops, and which delivers less fuel to the first fuel cell 303. Referring to FIG. 4, in certain other examples, an orifice plate 400 controls the amount of fuel supplied to at least one fuel cell 105. Fuel flows through a manifold, and passes through a constricted area 401, where the pressure drops, and which delivers less fuel to the first fuel cell. In other examples, other devices may be used to control the amount of fuel supplied to the fuel cell 105 such as needle valves, ball valves, angle-seat valves, butterfly valves, check valves, elliptic valves, metering valves, pinch valves, proportioning valves, solenoid valves pressure and/or temperature compensated variable flow valves, and flow regulators. A manifold may also be configured to supply a lower amount of fuel to at least one fuel cell of the fuel cell stack, e.g., one fuel inlet in the manifold may be constricted or have a smaller diameter than others to limit the fuel supplied to one of the fuel cells. It will be within the ability of the person of ordinary skill in the art, given the benefit of this disclosure, to select a suitable configuration to lower the amount of fuel supplied to the first fuel cell.

In certain examples, the fuel flow to the at least one fuel cell may be predetermined, and may be set based on calculations using various parameters including the unmodified fuel flow rate, the type of fuel cell, the size of the fuel cell, the fuel, oxidant, and electrolyte used, and nominal fuel concentration. In certain examples, the amount of fuel supplied to the at least one fuel cell may be about 10% to about 0.1% less than the amount of fuel supplied to other fuel cells in the fuel cell stack. In other examples, the amount of fuel supplied to the at least one fuel cell may be about 2% to about 0.1% less than the amount of fuel supplied to other fuel cells in the fuel cell stack.

In accordance with certain examples, the voltage output of the first fuel cell 105 subjected to a first condition may be measured, and monitored for a selected period. The voltage output of a second fuel cell 110 that is not subjected to a first condition may also be measured, and monitored for a selected period. In certain examples, the difference in voltage output between the first fuel cell 105 and the second fuel cell 110 may be monitored for a selected period. Without wishing to be bound by any particular scientific theory, a drop in voltage of the first fuel cell 105 below the voltage of the second fuel cell 110 may be indicative of a performance issue in the first fuel cell 105. This induced voltage drop, which may be induced by lowering of the fuel supplied to the first fuel cell, may be used as an indicator to predict the performance of the overall fuel cell stack 100. By inducing a voltage drop in at least one of the fuel cells in the fuel cell stack, an internal condition may be induced and used to adjust an operating condition when the performance of such other fuel cells approach the generated internal condition. More particularly, the lower amount of fuel provided to the first fuel cell 105 induces a condition that allows for an early indicator of potential performance issues in the other fuel cell 110, and other fuel cells of the fuel cell stack that are not subjected to a first condition. The first fuel cell may be used as an early indicator because when a performance issue arises, the issue may be first detected in the first fuel cell, which is more sensitive and susceptible to a voltage drop, before the issue may be detected in the other fuel cells that are operating with a suitable amount of fuel.

In accordance with certain other examples, a fuel cell stack is provided that comprises two or more fuel cells subjected to a first condition resulting in a lower fuel supply to these fuel cells. Referring to FIG. 2, the fuel cell stack 200 comprises fuel cells 205, 210, 215, 220, 225, and 230. Fuel cells 205, 210, 215, 220, 225 and 230 may share a common fuel inlet and outlet, and a common air inlet and outlet. Fuel cell 205 and 220 of the fuel cell stack 200 may be subjected to a first condition resulting in a lower amount of fuel supplied to these fuel cells. Referring to FIG. 3, in certain examples, a Venturi tube 300 controls the amount of fuel supplied to the fuel cells 205 and 220. Referring to FIG. 4, in certain other examples, an orifice plate 400 controls the amount of fuel supplied to fuel cells 205 and 220. In other examples, other devices may be used to control the amount of fuel supplied to the fuel cells 205 and 220 such as needle valves, ball valves, angle-seat valves, butterfly valves, check valves, elliptic valves, metering valves, pinch valves, proportioning valves, solenoid valves pressure and/or temperature compensated variable flow valves, and flow regulators. In certain examples, the first condition may be implemented by one means in one fuel cell, and by another means in another fuel cell. It will be within the ability of the person of ordinary skill in the art to select a suitable configuration to subject the fuel cells to conditions resulting in lower fuel supplies.

In certain examples, more than two fuel cells may be subjected to a condition resulting in lower fuel supply. In certain examples, a ratio of about 1 fuel cell subjected to a first condition to about 1000 fuel cells not subjected to a first condition may be used. In other examples, a ratio of about 1 fuel cell subjected to a first condition to about 110 fuel cells not subjected to a first condition may be used.

When more than one fuel cell is subjected to a condition resulting in lower fuel supply to these fuel cells, the voltage outputs of each of these fuel cells may be measured or otherwise monitored. The voltage output of one or more fuel cells that is not subjected to a first condition resulting in a lower fuel supply may also be measured. Referring again to FIG. 2, the fuel cells 205 and 220 may be subjected to conditions, which may be the same or may be different, resulting in lower fuel supply to these fuel cells. The voltage outputs of the fuel cells 205 and 220 may be measured. The voltage outputs of at least one of the fuel cells 210, 215, 225, and 230 may also be measured. The difference in voltage outputs of the fuel cell 205 and any of the fuel cells 210, 215, 225, or 230 may be monitored for a selected period. Additionally, the difference in voltage outputs of the fuel cell 220 and any of fuel cells 210, 215, 225, or 230 may be monitored for a selected period. By having two or more fuel cells that are subjected to a first condition resulting in a lower amount of fuel supplied to these fuel cells, performance issues throughout the stack may be monitored, and may provide for more accurate performance monitoring, and more uniform operation of the fuel cell stack.

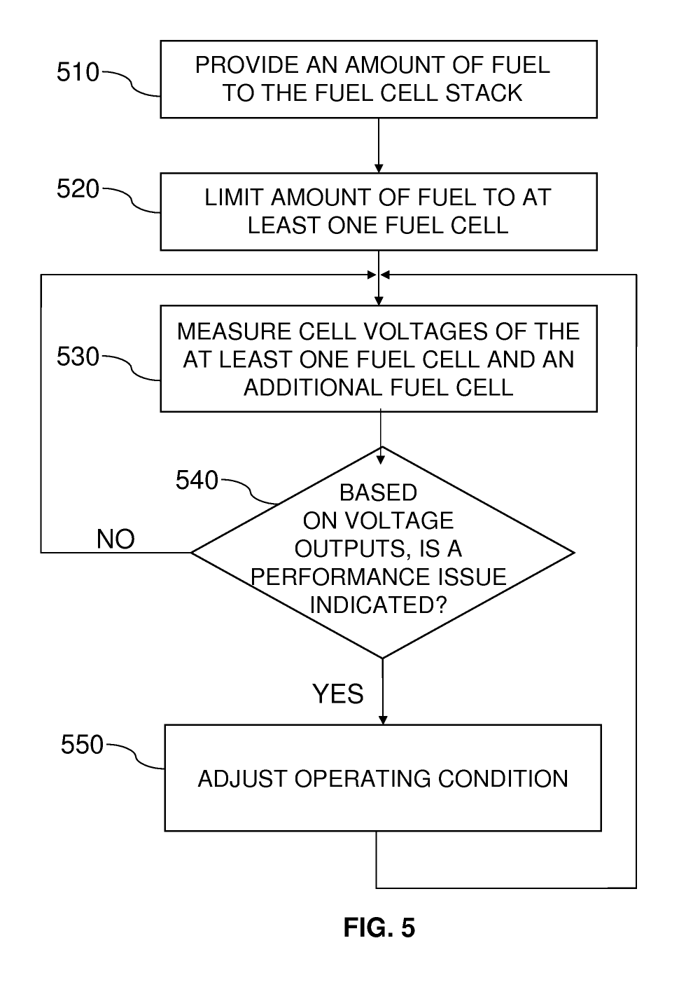

Referring to FIG. 5, during operation of the fuel cell system, an amount of fuel may be provided to the fuel cell stack in step 510. The amount of fuel provided to at least one fuel cell of the fuel cell stack may be limited or reduced compared to the amount of fuel provided to other fuel cells in the fuel cell stack in step 520, and voltage outputs of the at least one fuel cell provided with the limited amount of fuel and at least one additional fuel cell may be measured in step 530. Based on the voltage outputs, a control algorithm may determine whether a performance issue is indicated with the fuel cell stack in step 540. If a performance issue is indicated, an operating condition, discussed in more detail below, is adjusted in step 550. If a performance issue is not indicated, the fuel cell system continues to operate, and the control algorithm may continue to evaluate voltage outputs in step 530 to monitor performance of the fuel cell stack at selected or desired intervals.

In accordance with certain examples, an early indication from the first fuel cell may allow for adjustments to be made to operating conditions within the fuel cell system. In certain examples, the amount of fuel supplied may be adjusted, by either adjusting the flow or the concentration, or both. In other examples, the oxidant supply flow rate may be adjusted. In yet other examples, the temperature at which the fuel cell operates may be adjusted. In yet other examples, the pressure at which the fuel and/or oxidant are supplied to the fuel cell or fuel cell stack may be adjusted. In yet other examples, conditions external to the fuel cell system may be adjusted. In yet other examples, adjustment may include temporary or permanent shut down of at least one fuel cell, or of the fuel cell stack. In yet other examples, fuel concentration or fuel cell load may be adjusted.

In certain examples, adjustments may be made by either increasing or decreasing an operating condition. One or more operating conditions may be adjusted after an early indication of poor performance is observed. Additionally, more than one operating condition may be adjusted simultaneously. Adjustments may be made by individuals, using one or more algorithms or otherwise automatically by a controller programmed to make such adjustments in response to detection of poor performance.

In accordance with certain examples, an operating variable may be the voltage output of at least one fuel cell. This voltage output may be monitored for a selected period, and compared to a known voltage or voltage range. In certain examples, if the voltage output of a fuel cell is outside the known voltage range, providing an early indication of a performance issue, a second condition may be induced and used to adjust an operating condition of at least one fuel cell or the fuel cell system. In this example, the known voltage range may be voltages that indicate efficient operation of the fuel cell system, with no performance issues. If the voltage measurements are within the known voltage range, no second condition may be induced because no performance issue has been indicated. In certain other examples, if the voltage output of the fuel cell is within the voltage range, a second condition may be induced and used to adjust an operating condition of the at least one fuel cell or the fuel cell system. In this example, the known voltage range may be voltages that indicate inefficient operation of the fuel cell, with performance issues. If the voltage measurements are outside the known voltage range, no second condition may be induced because no performance issue has been indicated.

In accordance with certain examples, an operating variable may be the difference in voltage of a first fuel cell subjected to a first condition and an additional fuel cell. This voltage difference may be monitored for a selected period and may be compared to a known voltage difference or voltage difference range. In certain examples, if the voltage difference of the first fuel cell and an additional fuel cell is outside the known voltage range, providing an early indication of a performance issue, a second condition may be induced and used to adjust an operating condition of at least one fuel cell or the fuel cell system. In this example, the known voltage range may be voltage differences that indicate efficient operation of the fuel cell system, with no performance issues. If the monitored voltage differences are within the known voltage difference range, no second condition may be induced because no performance issue has been indicated. In certain other examples, if the voltage difference of the first fuel cell and an additional fuel cell is within the voltage range, providing an early indication of a performance issue, a second condition may be induced and used to adjust an operating condition of the at least one fuel cell or fuel cell system. In this example, the known voltage range may be voltage differences that indicate inefficient operation of the fuel cell, with performance issues. If the monitored voltage differences are outside the known voltage difference range, no second condition may be induced because no performance issue has been indicated.

In certain examples, a difference in voltage output between a first fuel cell subjected to a first condition, e.g., a lower amount of fuel, and a second fuel cell not subjected to the first condition, may vary from about −700 mV to about +700 mV, more particularly about −100 mV to about 100 mV. In certain examples, a difference in voltage output that may indicate a performance issue is about 10 millivolts (mV). In certain other examples, a significant performance issue may be indicated by a difference in voltage of about 400 mV. It will be recognized by the person of ordinary skill in the art, given the benefit of this disclosure, that the exact difference in voltage may vary depending on the type of fuel cell used.

In accordance with certain examples, the voltage may be measured using a voltmeter. In other examples, the voltage may be measured using a potentiometer, comparator circuit, A/D converter, or other suitable means for measuring voltage that will be selected by the person of ordinary skill in the art, given the benefit of this disclosure.

In certain examples, as the performance issue develops over time, the difference in voltage output may increase. In other examples, as the performance issue is resolved over time, the difference in voltage may decrease.

In accordance with certain examples, methanol fuel may be delivered to the fuel cell stack in a direct methanol fuel cell (DMFC) system. In this system, the fuel cell stack performance issues may include, for example, low concentration of fuel or fuel shortage, carbon dioxide bubble formation on the anode side of a fuel cell, and water droplet formation on the cathode side of a fuel cell. In certain examples, a direct methanol fuel cell system may include at least a first fuel cell and a second fuel cell configured to provide an operating variable. The fuel cell stack may be supplied with an amount of fuel. The first fuel cell may be subjected to a first condition resulting in a lower amount of fuel to the first fuel cell. During operation of the fuel cell, the voltage of at least the first fuel cell may be measured with a voltage measuring device. In certain examples, the voltage of at least one additional fuel cell may be measured. The voltage of the at least first fuel cell or the voltage output of the first fuel cell and the additional fuel cell may be monitored. If the voltage of the first fuel cell or the difference in voltage output is outside a threshold range, this is an indication that a performance issue may occur in the fuel cell system and may affect performance. This indication may induce adjustment of one or more operating conditions to prevent development of the performance issue throughout the fuel cell system.

In accordance with certain examples, the fuel cell stack performance issues may vary depending on the exact type of fuel cell present. Other performance issues may include water formation, low oxidant flow rate, or low fuel flow rate for a solid oxide PEM fuel cell. A high temperature PEM fuel cell may present low oxidant, insufficient fuel or insufficient cooling performance issues.

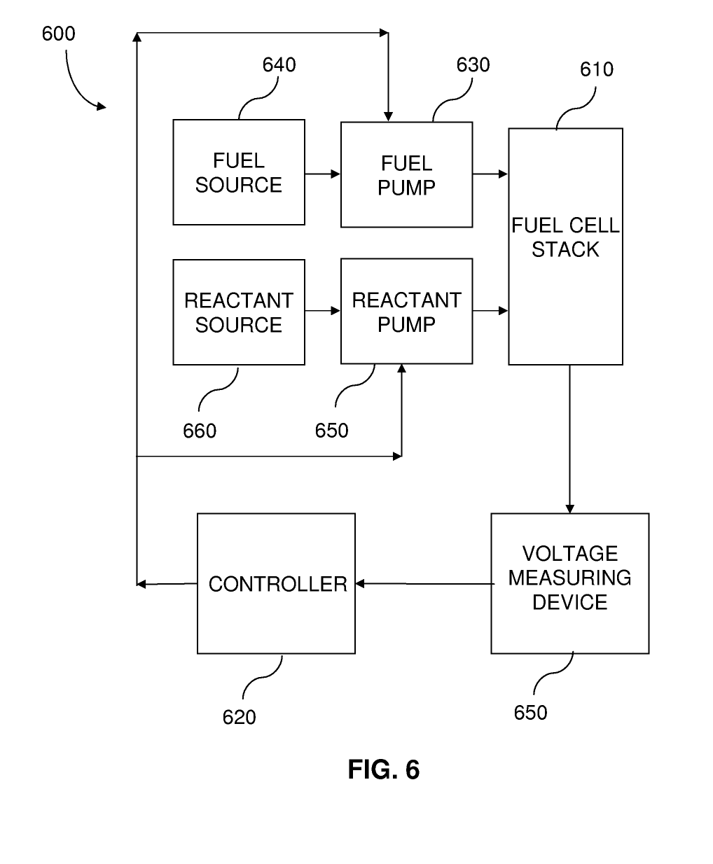

In accordance with certain examples, a fuel cell assembly is shown in FIG. 6. The fuel cell assembly 600 comprises a fuel cell stack 610 and a controller 620. In some examples, the fuel cell stack 610 is a fuel cell stack including at least two fuel cells. Fuel may be provided to the fuel cell stack 610, for example, by a fuel pump 630 fluidically coupled to a fuel source 640. The oxidant may be delivered to the fuel cell stack through an oxidant pump 650 fluidically coupled to an oxidant source 660. A first fuel cell of the fuel cell stack may be subjected to a first condition resulting in a lower amount of fuel supplied to the first fuel cell. During operation of the fuel cell stack, voltage outputs of the first fuel cell and an additional fuel cell may be measured by a voltage measuring device 650. The measured voltages may be provided to the controller 620, which may use the voltage outputs to control the fuel pump 630 and the oxidant pump 650. Various control algorithms may be used by the controller 620 to monitor fuel cell stack performance. By processing the cell voltage outputs of the first fuel cell and the second fuel cell, the controller 620 may predict a performance issue of the fuel cell stack 610. If the voltage output of the second fuel cell decreases below the voltage output of the first fuel cell, the controller 620 may receive a signal that causes the controller to adjust an operating condition of the fuel cell system. In certain examples, the controller 620 may regulate the fuel pump to increase fuel flow to the stack 610. In certain other examples, the controller 620 may regulate the fuel pump 630 to decrease the fuel flow. In certain other examples, based on the voltage output measurements, the controller 620 may not adjust the fuel flow.

In certain examples, a fuel cell assembly comprises a fuel cell stack comprising a first fuel cell and a second fuel cell. The assembly may include means for reducing the amount of fuel supplied to a first fuel cell. Means for reducing the amount of fuel supplied to a first fuel cell may include a Venturi tube, orifice plate, needle valves, ball valves, angle-seat valves, butterfly valves, check valves, elliptic valves, metering valves, pinch valves, proportioning valves, solenoid valves, pressure and/or temperature compensated variable flow valves, and flow regulators. The assembly may include means for measuring an operating variable of a first fuel cell and a second fuel cell. If the operating variable is a voltage output, the means for measuring an operating variable may include a voltmeter, potentiometer, or oscilloscope. If the operating variable is temperature, means for measuring an operating variable may include a thermocouple or thermometer. The assembly may include means for comparing the operating variable of the first fuel cell and the second fuel cell. Means for comparing may include a computer algorithm, a comparator circuit, a differential amplifier circuit, or any voltage measuring circuit. Additionally, the assembly may include means for controlling the operating variable of at least one of the first and second fuel cells to maintain the performance of the fuel cell stack. Means for controlling the operating variable of at least one of the first and second fuel cells may include adjusting one or more operating conditions of the at least first or second fuel cell or the fuel cell stack. Adjustments may be made to the fuel flow rate, oxidant flow rate, the operating temperature of the fuel cell, the pressure at which the fuel and/or oxidant are supplied, or fuel concentration. In some examples, means for controlling the operating variable of at least one of the first and second fuel cells may include adjustments that are external to the fuel cell system. In other examples, adjustment may include temporary or permanent shut down of at least one fuel cell, or of the fuel cell stack. Means for controlling may be performed automatically, by a computer algorithm, manually, or a fault detection circuit. In certain examples, the fuel cell assembly may include a fuel cell stack performance issue notification system. In some examples, the notification system may be configured to provide an audible indication if there is detection of a potential performance issue. In other examples, the notification system may be configured to provide a visual warning if there is detection of a potential performance issue. This performance issue notification may be integrated into the control algorithm or may exist separately.

Although the fuel cell stacks and monitoring systems and methods of using them have been described above in terms of certain examples, various alterations, modifications, substitutions, additions and improvements will be readily apparent to the person of ordinary skill in the art, given the benefit of the disclosure. Such alterations, modifications, substitutions, additions and improvements are intended to be within the scope and spirit of the fuel cell stacks and fuel cell monitoring system disclosed here. It is also intended that the indefinite articles “a” and “an,” as used above and in the appended claims, mean one or more of the articles which they modify, and that the terms “include,” “including” and “having” are interchangeable with the open ended term “comprising.”

What is claimed is:

1. A fuel cell system configured to provide an operating variable to monitor fuel cell stack performance, the fuel cell system comprising a first fuel cell and a second fuel cell, the first fuel cell configured to receive a lower amount of fuel than the second fuel cell in a first condition to provide an operating variable indicative of fuel cell stack performance.

2. The fuel cell system of claim 1, wherein the operating variable is a voltage difference between the first fuel cell and the second fuel cell.

3. The fuel cell system of claim 1, wherein the operating variable is a voltage output of at least one of the first and second fuel cells.

4. The fuel cell system of claim 1, further comprising a device coupled to at least one of the first fuel cell and the second fuel cell and configured to detect the operating variable to monitor fuel cell stack performance.

5. The fuel cell system of claim 1, further comprising a voltage measurement device coupled to at least one of the first fuel cell and the second fuel cell and configured to provide a voltage measurement as the operating variable to monitor fuel cell stack performance.

6. The fuel cell system of claim 1, wherein the first condition provides a voltage output of the first fuel cell that is compared to a voltage output of the second fuel cell to monitor fuel cell stack performance.

7. The fuel cell system of claim 1, further comprising a device fluidically coupled to the first fuel cell and configured to limit the amount of fuel supplied to the first fuel cell.

8. The fuel cell system of claim 7, in which the device configured to limit the amount of fuel supplied to the first fuel cell is a tube or an orifice plate.

9. The fuel cell system of claim 1, further comprising a fuel source fluidically coupled to the first fuel cell and the second fuel cell.

10. The fuel cell system of claim 9, wherein the fuel source is methanol.

11. The fuel cell system of claim 1, wherein the fuel cell system is configured to provide an operating variable to monitor fuel cell stack performance to limit fuel cell stack performance issues, the fuel cell stack performance issues selected from the group consisting of low concentration of fuel, fuel shortage, carbon dioxide bubble formation, water droplet formation, and combinations thereof.

12. A fuel cell system comprising a controller and a fuel cell stack that comprises a first fuel cell and a second fuel cell, the fuel cell stack configured to provide feedback to the controller regarding fuel cell stack performance after a first condition is induced in the first fuel cell.

13. The fuel cell system of claim 12, wherein the controller adjusts the amount of fuel supplied if the feedback is outside of a threshold range.

14. The fuel cell system of claim 12, wherein the controller adjusts the amount of fuel supplied if the feedback is within a threshold range.

15. The fuel cell system of claim 12, wherein the feedback is a difference between a first fuel cell voltage output and a second fuel cell voltage output, the first condition induced under a decreased amount of fuel supplied to a first fuel cell.

16. A fuel cell assembly comprising:
a fuel cell stack comprising a first fuel cell and a second fuel cell;
means for reducing the amount of fuel supplied to a first fuel cell;
means for measuring an operating variable of the first fuel cell and the second fuel cell;
means for comparing the operating variable of the first fuel cell and the second fuel cell; and
means for the operating variable of at least one of the first and second fuel cells to maintain the performance of the fuel cell stack.

17. The fuel cell assembly of claim 16, wherein a controller is configured to provide a change in the amount of fuel supplied if the operating variable is outside of a threshold range.

18. The fuel cell assembly of claim 16, wherein a controller is configured to provide a change in the amount of fuel supplied if the operating variable is within a threshold range.

19. The fuel cell assembly of claim 16, wherein a voltage measuring device is coupled to the first fuel cell and the second fuel cell and is configured to provide a voltage measurement of the first fuel cell and the second fuel cell.

20. A method of monitoring performance of a fuel cell stack comprising at least a first fuel cell and a second fuel cell, the method comprising:
subjecting the first fuel cell of the fuel cell stack to a first condition resulting in a lower amount of fuel supplied to the first fuel cell;
detecting a first voltage output of the first fuel cell of the fuel cell stack at the first condition; and
monitoring performance of at least one other fuel cell in the fuel cell stack using the detected, first voltage output.

21. The method of claim 20, further comprising detecting an additional voltage output from the second fuel cell of the fuel cell stack; and
comparing the detected, first voltage output and the detected, additional voltage output to assess performance of the fuel cell stack.

22. The method of claim 21, further comprising inducing a second condition in the fuel cell stack in response to the assessed performance.

23. The method of claim 22, in which the second condition comprises adjusting the amount of fuel supplied to the fuel cell stack.

24. The method of claim 21, further comprising controlling the fuel flow of the fuel cell stack based on the detected, first voltage output and the detected, additional voltage output.

25. A method of determining performance of a fuel cell stack, the method comprising limiting fuel supplied to a first fuel cell of the fuel cell stack to induce a performance condition in the first fuel cell to prevent occurrence of the induced performance condition in at least one other fuel cell in the fuel cell stack.

26. The method of claim 25, further comprising measuring a first voltage output of the first fuel cell to determine the performance condition.

27. The method of claim 26, further comprising measuring a second voltage output of a second fuel cell, and comparing the first voltage output and the second voltage output to determine the performance condition.

28. A power system configured to provide a voltage output, the power system comprising a first voltage generating device and a second voltage generating device coupled to the first voltage generating device, wherein the power system is configured to provide an operating variable indicative of poor performance that is used to monitor performance of the power system.

29. The power system of claim 28, wherein at least one of the first and second voltage generating devices is selected from the group consisting of a fuel cell, a photovoltaic cell and battery.
